(19) United States
(12) Patent Application Publication
(10) Pub. No.: US 2016/0167348 A1
(43) Pub. Date: Jun. 16, 2016

(54) MULTILAYER POLYMERIC SHEETS AND LIGHT WEIGHT LAMINATES PRODUCED THEREFROM

(71) Applicant: E. I. DU PONT DE NEMOURS AND COMPANY, Wilmington, DE (US)

(72) Inventors: Stephen J. Bennison, Wilmington, DE (US); Toshikazu Kobayashi, Nagoya (JP); Shannon D. Meerscheidt, Bridge City, TX (US); Kazuyuki Nakata, Chiba (JP); Steven C. Pesek, Orange, TX (US); W. Alexander Shaffer, Orange, TX (US); Yuki Shitanoki, Utsunomiya (JP); Charles Anthony Smith, Vienna, WV (US)

(21) Appl. No.: 14/906,139

(22) PCT Filed: Jul. 22, 2014
(86) PCT No.: PCT/US2014/047547

§ 371 Date: Jan. 19, 2016

Related U.S. Application Data
(60) Provisional application No. 61/856,820, filed on Jul. 22, 2013.

(51) Int. Cl. B32B 27/08; B32B 27/20; B32B 17/10

(52) U.S. Cl. CPC B32B 27/08; B32B 17/10018; B32B 17/10036; B32B 17/10678; B32B 27/20; B32B 2307/56

(57) ABSTRACT

A multilayer polymeric sheet comprising three layers is provided. The two outer layers of the multilayer polymeric sheet comprise an ionomeric composition and are positioned on either side of the inner layer of the multilayer polymeric sheet, which comprises an ethylene vinyl acetate (EVA) composition. Further provided is a laminate comprising the multilayer polymeric sheet, for example, a glass laminate. Preferred laminates exhibit a sound transmission class of greater than 25, as measured by ASTM E314, or an effective stiffness by bending of about 3.0 mm to about 5.0 mm, as measured by ASTM C158. Also preferably, the laminate has an areal density that is lower than that of a glass monolith of comparable thickness.

### FIELD OF THE INVENTION

This invention relates to multilayer polymeric sheets and light weight laminates produced therefrom. The laminates also have improved acoustic barrier properties.

### BACKGROUND OF THE INVENTION

Several patents and publications are cited in this description in order to more fully describe the state of the art to which this invention pertains. The entire disclosure of each of these patents and publications is incorporated by reference herein.

Glass laminated products for safety glass applications are characterized by high impact and penetration resistance. These laminates, which do not scatter glass shards and debris when shattered, typically consist of a sandwich of two glass sheets or panels bonded together with an interlayer of a polymeric film or sheet that is placed between the two glass sheets. One or both of the glass sheets may be replaced with optically clear rigid polymeric sheets, such as sheets of polycarbonate materials. Safety glass has further evolved to include multiple layers of glass sheets (or optically clear rigid polymeric sheets that are used in place of the glass) bonded together with interlayers of polymeric films or sheets.

The interlayer is typically made with a relatively thick polymer film or sheet, which exhibits toughness and bondability to provide adhesion to the glass in the event of a crack or crash. Over the years, a wide variety of polymeric interlayers have been developed to produce laminated products. In general, these polymeric interlayers must possess a combination of characteristics including very high optical clarity (low haze), high impact resistance, high penetration resistance, excellent ultraviolet light resistance, good long term thermal stability, excellent adhesion to glass and other rigid polymeric sheets, low ultraviolet light transmittance, low moisture absorption, high moisture resistance, excellent long term weatherability, among other requirements. Widely used interlayer materials utilized currently include complex, multicomponent compositions based on polyvinylbutyral (PVB), polyurethane (PU), polyvinylchloride (PVC), linear low density polyethylenes (preferably metallocene-catalyzed), ethylene vinyl acetate (EVA), polymeric fatty acid polyamides, polyester resins, such as poly(ethylene terephthalate), silicone elastomers, epoxy resins, elastomeric polycarbonates, ionomers and the like.

A part of this trend has been the use of copolyethylene ionomer resins as the glass laminate interlayer material. Such ionomer resins offer significantly higher strength than found for the other common interlayer materials, such as polyvinyl butyral and ethylene vinyl acetate materials. See, e.g., U.S. Pat. Nos. 3,344,014; 4,663,228; 4,668,574; 4,799,346; 5,002,820; and 5,763,062; and International Patent Appln. Publn. Nos. WO99/58334 and WO2004/011755. In addition, advances have been made in providing ionomeric resins with improved clarity. See, e.g., U.S. Pat. Nos. 8,399,096 and 8,399,097.

Multilayer laminate constructions that include ionomeric interlayer materials have been described in the art. For example Clock et al., in U.S. Pat. No. 3,762,988, describe a glass laminate multilayer interlayer with poly(ethylene-co-methacrylic acid) materials that have been neutralized with metal ions or amines as the core layer and a load distribution layer. Friedman et al., in U.S. Pat. No. 6,432,522, describe optically transparent glazings that include an interlayer film comprising at least two polymeric film layers: a core layer having a modulus of at least 25,000 psi, which may be an ionomeric material, and a surface film layer having a maximum modulus of 15,000 psi. Vogel et al., in U.S. Patent Appln. Publn. Nos. 2002/0055006 and 2005/0106386, describe a multilayer film or sheet comprising: a) a first co-extruded polymeric layer consisting essentially of ionomer, and b) at least one co-extruded second polymeric layer selected from the group consisting of ionomer, ionomer-polyethylene blend and ionomer-polyamide blend. Roberts et al., in U.S. Patent Appln. Publn. No. 2005/0136263, describe a flexible window comprising a transparent multilayer sheet, which in turn comprises a transparent flexible base layer formed of a substantially plasticizer free polymeric material that may include ionomers and a first transparent flexible protective layer that has a greater abrasion resistance than the transparent flexible base layer. The transparent multilayer sheet is sufficiently flexible to be rolled into a cylindrical shape without cracking or fracturing. Durbin et al., in Intl. Patent Appln. Publn. No. WO 01/60604, describe a laminated glazing that includes a transparent flexible plastic which reflects infra-red radiation and which is bonded between a ply of ionomer resin and a ply of a polymer material that has a higher viscosity than the ionomer layer. Samuels et al., in U.S. Pat. No. 8,101,267, describe an encapsulant comprising three layers of ionomeric material, in which the middle ionomeric layer has a modulus that is lower than that of the ionomeric material in the outer layers. Finally, Lenges et al., in U.S. Patent Appln. Publn. No. 2012/0067420A11 and in U.S. Pat. No. 8,080,728, describe tri-layered interlayers having two ionomeric outer layers and a non-ionomeric middle layer.

Society continues to demand more functionality from laminated glass products beyond the safety and strength characteristics described above. For example, it is desirable for the glass laminate to function as an acoustic barrier to reduce the level of noise intrusion into the structure that the glass laminate is attached to, such as a building or an automobile. Acoustic laminated glass is generally known within the art and has been described in U.S. Pat. Nos. 5,190,826; 5,340,654; 5,368,917; 5,464,659; 5,478,615; 5,773,102; 6,074,732; 6,119,807; 6,132,882; 6,432,522; and 6,825,255; and in Intl. Patent Appln. Publn. Nos. WO01/19747 and WO2004/039581, for example. Acoustic glass laminates typically includes a low modulus, heavily plasticized poly(vinyl acetal) sheet. Laminates produced from such materials however, suffer the shortcomings associated with low penetration resistance. For example, the acoustic laminates may not have adequate strength or stiffness to act as safety laminates.

It is apparent from the foregoing that a need remains for interlayer sheets and light weight laminates that provide improved acoustic barrier properties while maintaining the high clarity, adhesion, penetration resistance, stiffness, and strength commonly considered necessary for safety glass performance.

### SUMMARY OF THE INVENTION

Accordingly, provided herein is a multilayer polymeric sheet comprising three layers. The two outer layers of the multilayer polymeric sheet comprise an ionomeric composition and are positioned on either side of an inner layer of the multilayer polymeric sheet. The inner layer comprises an ethylene vinyl acetate composition. Preferably, the outer ionomer-comprising layers are between about 0.1 mm and about 1.5 mm thick. Also preferably, the inner ethylene vinyl acetate-comprising layer is between about 0.1 mm and about 1.5 mm thick, and the overall thickness of the multilayer polymeric sheet is between about 0.3 mm and about 2.0 mm thick. The outer ionomer-comprising layers can be ionomers of dipolymers or terpolymers, for example.

Further provided is a laminate comprising the multilayer polymeric sheet and at least one additional layer. In a preferred laminate, the multilayer polymeric sheet is placed between two layers of glass and laminated to form a multilayer polymeric laminate; each layer of glass is between about 0.5 mm and about 2.0 mm thick; and the total thickness of said multilayer polymeric laminate is between about 1.5 mm and about 7.0 mm thick. Preferred laminates exhibit a sound transmission class of greater than 25, as measured by ASTM E314, or an effective stiffness by bending of about 3.0 mm to about 5.0 mm, as measured by ASTM C158. Also preferably, the laminate has a lower areal density than a monolithic glass of comparable thickness and bending strength.

### DETAILED DESCRIPTION OF THE INVENTION

The following definitions are used herein to further define and describe the disclosure. These definitions apply to the terms as used throughout this specification, unless otherwise limited in specific instances.

Unless otherwise defined, all technical and scientific terms used herein have the same meaning as commonly understood by one of ordinary skill in the art to which this invention belongs. In case of conflict, the present specification, including the definitions set forth herein, will control.

Unless explicitly stated otherwise in defined circumstances, all percentages, parts, ratios, and like amounts used herein are defined by weight.

When materials, methods, or machinery are described herein with the term “known to those of skill in the art”, “conventional” or a synonymous word or phrase, the term signifies that materials, methods, and machinery that are conventional at the time of filing the present application are encompassed by this description. Also encompassed are materials, methods, and machinery that are not presently conventional, but that will have become recognized in the art as suitable for a similar purpose.

As used herein, the terms “comprises,” “comprising,” “includes,” “including,” “containing,” “characterized by,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The transitional phrase “consisting of” excludes any element, step, or ingredient not specified in the claim, closing the claim to the inclusion of materials other than those recited except for impurities ordinarily associated therewith. When the phrase “consists of” appears in a clause of the body of a claim, rather than immediately following the preamble, it limits only the element set forth in that clause; other elements are not excluded from the claim as a whole.

The transitional phrase “consisting essentially of” limits the scope of a claim to the specified materials or steps and those that do not materially affect the basic and novel characteristic(s) of the claimed invention. A “consisting essentially of” claim occupies a middle ground between closed claims that are written in a “consisting of” format and fully open claims that are drafted in a “comprising” format. Optional additives as defined herein, at levels that are appropriate for such additives, and minor impurities are not excluded from a composition by the term “consisting essentially of”.

When a composition, a process, a structure, or a portion of a composition, a process, or a structure, is described herein using an open-ended term such as “comprising,” unless otherwise stated the description also includes an embodiment that “consists essentially of” or “consists of” the elements of the composition, the process, the structure, or the portion of the composition, the process, or the structure.

Further in this connection, certain features of the invention which are, for clarity, described herein in the context of separate embodiments, may also be provided in combination in a single embodiment. Conversely, various features of the invention that are, for brevity, described in the context of a single embodiment, may also be provided separately or in any sub-combination.

The articles “a” and “an” may be employed in connection with various elements and components of compositions, processes or structures described herein. This is merely for convenience and to give a general sense of the compositions, processes or structures. Such a description includes “one or at least one” of the elements or components. Moreover, as used herein, the singular articles also include a description of a plurality of elements or components, unless it is apparent from a specific context that the plural is excluded.

Further, unless expressly stated to the contrary, the conjunction “or” refers to an inclusive or and not to an exclusive or. For example, the condition “A or B” is satisfied by any one of the following: A is true (or present) and B is false (or not present), A is false (or not present) and B is true (or present), and both A and B are true (or present). Exclusive “or” is designated herein by terms such as “either A or B” and “one of A or B”, for example.

The term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such.

In addition, the ranges set forth herein include their endpoints unless expressly stated otherwise. Further, when an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed. The scope of the invention is not limited to the specific values recited when defining a range.

The term “alkyl”, as used herein alone or in combined form, such as, for example, “alkyl group” or “alkoxy group”, refers to saturated hydrocarbon groups that have from 1 to 8 carbon atoms having one substituent and that may be branched or unbranched.

As used herein, the term “copolymer” refers to polymers comprising copolymerized units resulting from copolymerization of two or more comonomers. In this connection, a copolymer may be described herein with reference to its constituent comonomers or to the amounts of its constituent comonomers, for example “a copolymer comprising ethylene and 18 weight % of acrylic acid”, or a similar description. Such a description may be considered informal in that it does not refer to the comonomers as copolymerized units; in that it does not include a conventional nomenclature for the copolymer, for example International Union of Pure and Applied Chemistry (IUPAC) nomenclature; in that it does not use product-by-process terminology; or for another reason. As used herein, however, a description of a copolymer with reference to its constituent comonomers or to the amounts of its constituent comonomers means that the copolymer contains copolymerized units (in the specified amounts when specified) of the specified comonomers. It follows as a corollary that a copolymer is not the product of a reaction mixture containing given comonomers in given amounts, unless expressly stated in limited circumstances to be such. The term “copolymer” may refer to polymers that consist essentially of copolymerized units of two different monomers (a dipolymer), or that consist essentially of more than two different monomers (a terpolymer consisting essentially of three different comonomers, a tetrapolymer consisting essentially of four different comonomers, etc.).

The term “acid copolymer”, as used herein, refers to a polymer comprising copolymerized units of an α-olefin, an α,β-ethylenically unsaturated carboxylic acid or its anhydride, and optionally other suitable comonomer(s), such as vinyl acetate or an α,β-ethylenically unsaturated carboxylic acid ester.

The term “ionomer”, as used herein, refers to a polymer that is produced by partially or fully neutralizing an acid copolymer.

The terms “melt index” (“MI”) and “melt flow rate” (“MFR”) are synonymous and used interchangeably herein. Unless otherwise specified in limited circumstances, the melt indices reported herein are in units of “grams per 10 minutes” (“g/10 min”) and are measured by ASTM Method No. D1238-13 at a temperature of 190° C. and under a weight of 2.16 kg.

The term “laminate”, as used herein alone or in combined form, such as “laminated” or “lamination” for example, refers to a structure having at least two layers that are adhered or bonded firmly to each other, optionally using heat, vacuum or positive pressure. The layers may be adhered to each other directly or indirectly. In this context, the term “directly” means that there is no additional material, such as an interlayer, an encapsulant layer or an adhesive layer, between the two layers, and the term “indirectly” means that there is additional material between the two layers.

Provided herein is a multilayer polymeric laminate that comprises three layers of polymeric materials laminated such that the two outer layers are on either side of the inner layer. Preferably, the outer layers are laminated directly to the inner layer. In the context of describing the fabrication of the multilayer polymeric laminate, the term “laminate”, used alone or in combined form, may refer to a structure that is prepared by a method other than adhering individual layers, as described in greater detail below.

Preferably, the thickness of the multilayer polymeric sheet is about 0.30 to about 2.0 mm, more preferably about 0.35 to about 1.5 mm. The individual layers of the multilayer polymeric sheet may have any thickness; their thicknesses may be the same or different. Preferably, however, the sum of the individual layers' thicknesses is about 0.30 to about 2.0 mm, more preferably about 0.35 to about 1.5 mm. Also, the thickness of each of the outer layers and of the inner layer is generally between about 0.1 mm and 1.5 mm.

The individual layers in the multilayer polymeric sheet of the present invention may also be described with reference to the ratios of their thicknesses. The ratio of the thicknesses of the individual layers may be any that is convenient, but generally will be such that the outer layers are of approximately the same thickness. Stated alternatively, the ratio of the thicknesses of the outer two layers is preferably about 1/1. Preferred ratios of the thicknesses of the individual layers of the multilayer polymeric sheet include but are not limited to 1/1/1, 2/5/2, and 4/1/4, given in order of outer/inner/outer layers.

In one embodiment, the polymeric material of the inner layer is an ethylene vinyl acetate (EVA) material. Generally, the EVA material comprises poly(ethylene-co-vinyl acetate) having a vinyl acetate content of greater than 25 wt %, preferably about 25 to about 70 wt % or about 25 to about 50 wt %, more preferably between about 30 and about 46 wt % or between about 30 and about 35 wt %, based on the total weight of the EVA material. The amount of copolymerized residues of ethylene in the EVA material is complementary to the amounts of copolymerized vinyl acetate and additional comonomer(s), if any. Stated alternatively, 100 wt % is the sum of the weight percentages of the copolymerized comonomer residues in the EVA material. In addition, the EVA material preferably has an initial melt flow index (before cross-linking) of about 14 g/10 min, and a final melt flow index (after cross-linking) of 2 g/10 min or lower, preferably 1.5 g/10 min or lower, more preferably 0.5 g/10 min, after the material is cross-linked by one or more of the methods described herein.

The ionomeric compositions of the two outer layers may be the same or different. When the ionomeric compositions are different, each parameter of the ionomeric compositions is selected independently. The parameters of the ionomeric compositions include, without limitation, the identity and amounts of the comonomers in the acid terpolymers, the neutralization level of the terionomers, the counterion(s) in the terionomers, the melt indices of the acid terpolymers and the terionomers, the additives in each composition, and the like.

The ionomeric composition comprises an ionomer that is a neutralized product of an acid copolymer. Preferably, the ionomer is a terionomer that is a neutralized product of an acid terpolymer. The acid copolymer comprises copolymerized residues of an alpha olefin and copolymerized residues of an alpha,beta-ethylenically unsaturated carboxylic acid. Preferred acid copolymers are terpolymers of an alpha olefin, a first alpha,beta-ethylenically unsaturated carboxylic acid, and an ester of a second alpha,beta-ethylenically unsaturated carboxylic acid. As is noted above, the acid terpolymer is partially neutralized to form the terionomer, which comprises carboxylate salts having counterions.

Suitable alpha olefins for use in the acid copolymers comprise from 2 to 10 carbon atoms. Preferably, the alpha olefin is selected from the group consisting of ethylene, propylene, 1-butene, 1-pentene, 1-hexene, 1-heptene, 3-methyl-1-butene, 4-methyl-1-pentene, and the like and combinations of two or more of these alpha olefins. More preferably, the alpha olefin is ethylene.

The amount of copolymerized residues of alpha olefin in the acid copolymer is complementary to the amounts of copolymerized acid(s) and other comonomer(s), if any. Stated alternatively, 100 wt % is the sum of the weight percentages of the copolymerized comonomer residues in the acid copolymer.

Preferred first alpha,beta-ethylenically unsaturated carboxylic acids have from 3 to 8 carbon atoms. More preferably, the first alpha, beta-ethylenically unsaturated carboxylic acid is selected from the group consisting of acrylic acids including methacrylic acid; itaconic acid; maleic acid; maleic anhydride; fumaric acid; monomethyl maleic acid; and the like and combinations of two or more of these acids. More preferably, the first alpha, beta-ethylenically unsaturated carboxylic acid component is selected from the group consisting of acrylic acid, methacrylic acid, and a combination of acrylic acid and methacrylic acid.

The acid terpolymer incorporates from about 0.1 to about 30 wt % of copolymerized repeat units of the first alpha, beta-ethylenically unsaturated carboxylic acid, based on the total weight of the acid terionomer. Preferably, the acid terpolymer incorporates from about 5 to about 25 wt % of copolymerized repeat units of the first alpha, beta-ethylenically unsaturated carboxylic acid, based on the total weight of the acid terionomer. More preferably, the acid terpolymer incorporates from about 15 to about 25 wt % of copolymerized repeat units of the first alpha, beta-ethylenically unsaturated carboxylic acid, based on the total weight of the acid terpolymer. In some preferred embodiments, the acid terpolymer incorporates from about 20 to about 25 wt % of copolymerized repeat units of the first alpha, beta-ethylenically unsaturated carboxylic acid.

The acid terpolymers also comprise copolymerized residues of an alkyl ester of a second alpha, beta-ethylenically unsaturated carboxylic acid. Suitable and preferred second alpha, beta-ethylenically unsaturated carboxylic acids are as set forth above with respect to the first alpha, beta-ethylenically unsaturated carboxylic acid. Suitable alkyl groups are as defined above. Preferred are alkyl groups containing 1 to 4 carbon atoms. Methyl esters, ethyl esters, n-butyl esters and i-butyl esters are more preferred. Suitable acid terpolymers include about 2 to about 25 wt % of copolymerized residues of the alkyl ester of the second alpha, beta-ethylenically unsaturated carboxylic acid, based on the total weight of the acid terpolymer. Preferred acid terpolymers include about 5 to about 20 wt % of copolymerized residues of the alkyl ester of the second alpha, beta-ethylenically unsaturated carboxylic acid, and more preferred acid terpolymers include about 7 to about 15 wt % of copolymerized residues of the alkyl ester of the second alpha, beta-ethylenically unsaturated carboxylic acid, based on the total weight of the acid terpolymer.

Also suitable for use in the ionomeric composition are other ethylene acid copolymers, which differ from the acid terpolymers in that they do not contain copolymerized residues of the alkyl ester of the second alpha, beta-ethylenically unsaturated carboxylic acid (i.e., acid dipolymers). Preferred acid dipolymers include the amounts of acid that are described above as suitable with respect to acid terpolymers. Alternatively, the other ethylene acid copolymers differ from the acid terpolymers in that they contain copolymerized residues of one or more other unsaturated comonomers in addition to the alpha olefin, the first alpha, beta-ethylenically unsaturated carboxylic acid, and the alkyl ester of the second alpha, beta-ethylenically unsaturated carboxylic acid (i.e., tetrapolymers or copolymers of more than four comonomers).

Suitable other unsaturated comonomers include, without limitation, methyl acrylate, methyl methacrylate, ethyl acrylate, ethyl methacrylate, propyl acrylate, propyl methacrylate, isopropyl acrylate, isopropyl methacrylate, butyl acrylate, butyl methacrylate, isobutyl acrylate, isobutyl methacrylate, tert-butyl acrylate, tert-butyl methacrylate, octyl acrylate, octyl methacrylate, undecyl acrylate, undecyl methacrylate, octadecyl acrylate, octadecyl methacrylate, dodecyl acrylate, dodecyl methacrylate, 2-ethylhexyl acrylate, 2-ethylhexyl methacrylate, isobornyl acrylate, isobornyl methacrylate, lauryl acrylate, lauryl methacrylate, 2-hydroxyethyl acrylate, 2-hydroxyethyl methacrylate, glycidyl acrylate, glycidyl methacrylate, poly(ethylene glycol)acrylate, poly(ethylene glycol)methacrylate, poly(ethylene glycol) methyl ether acrylate, poly(ethylene glycol) methyl ether methacrylate, poly(ethylene glycol) behenyl ether acrylate, poly(ethylene glycol) behenyl ether methacrylate, poly(ethylene glycol) 4-nonylphenyl ether acrylate, poly(ethylene glycol) 4-nonylphenyl ether methacrylate, poly(ethylene glycol) phenyl ether acrylate, poly(ethylene glycol) phenyl ether methacrylate, dimethyl maleate, diethyl maleate, dibutyl maleate, dimethyl fumarate, diethyl fumarate, dibutyl fumarate, dimenthyl fumarate, vinyl acetate, vinyl propionate and the like and combinations of two or more of these other comonomers. Preferably, the other unsaturated comonomers are selected from the group consisting of methyl acrylate, methyl methacrylate, ethyl acrylate, ethyl methacrylate, butyl acrylate, butyl methacrylate, iso-butyl acrylate, iso-butyl methacrylate, glycidyl methacrylate, vinyl acetate and combinations of two or more of these acrylates.

The level of the other unsaturated comonomer may be adjusted to provide an ionomeric material with the desired properties, for example, the desired modulus. Preferably, the other ethylene acid copolymer comprises between 0 and about 50 wt % of copolymerized repeat units of the other unsaturated comonomer, based on the total weight of the acid copolymer. More preferably, the other ethylene acid copolymer comprises between 0 and about 35 wt % or between 0 and about 5 wt % of copolymerized repeat units of the other unsaturated comonomer, based on the total weight of the acid copolymer. In some preferred embodiments, however, the other ethylene acid copolymer comprises between about 5 and about 30 wt % of copolymerized repeat units of the other unsaturated comonomer, based on the total weight of the acid copolymer. In many preferred embodiments, however, the acid copolymer is an acid dipolymer or an acid terpolymer, that is, an acid copolymer that does not contain a significant amount of the other unsaturated comonomer.

Preferred acid copolymers have a melt index of up to about 400 g/10 min, as measured by ASTM Method No. D1238 13 at a temperature of 190° C. and under a weight of 2.16 kg. More preferably, the acid copolymers have a melt index of at least about 10 g/10 min, about 20 g/10 min, about 45 g/10 min, or about 55 g/10 min. Also more preferably, the acid copolymers have a melt index of up to about 65 g/10 min, about 75 g/10 min, about 100 g/10 min, about 120 g/10 min, or about 200 g/10 min.

The acid terpolymers and other acid copolymers can be synthesized by methods described in U.S. Pat. Nos. 3,264,272; 3,355,319; 3,404,134; 3,520,861; 4,248,990; 5,028,674; 5,057,593; 5,827,559; 6,500,888 and 6,518,365, for example.

To obtain the ionomers, the acid copolymers are neutralized with a base so that the carboxylic acid groups in the precursor acid copolymer react to form carboxylate groups. Preferably, the precursor acid copolymers groups are neutralized to a level of about 5 to about 100%, or about 10% to about 90%, or about 15% to about 50%, or about 20% to about 30%, based on the total carboxylic acid content of the acid copolymers as calculated or as measured for the non-neutralized acid copolymers.

Any stable cation and any combination of two or more stable cations are believed to be suitable as counterions to the carboxylate groups in the ionomer. As used in this context, the term “stable” refers to a cation that does not decompose to form an undesirable product under the conditions of polymer synthesis, polymer processing, or laminate fabrication. The cations are typically introduced into the ionomer as the counterion(s) of the base(s) with which the acid copolymer is neutralized.

Metal ions are preferred cations, and suitable metal ions may be monovalent, divalent, trivalent, multivalent or a combination of cations of different valencies. Preferred monovalent metal ions are selected from the group consisting of sodium, potassium, lithium, silver, mercury, copper and mixtures thereof. Preferred divalent metal ions are selected from the group consisting of beryllium, magnesium, calcium, strontium, barium, copper, cadmium, mercury, tin, lead, iron, cobalt, nickel, zinc and mixtures thereof. Preferred trivalent metal ions are selected from the group consisting of aluminum, scandium, iron, yttrium and mixtures thereof. Preferred multivalent metal ions are selected from the group consisting of titanium, zirconium, hafnium, vanadium, tantalum, tungsten, chromium, cerium, iron and mixtures thereof. Preferably, when the metal ion is multivalent, complexing agents, such as stearate, oleate, salicylate, and phenolate radicals are included, as described in U.S. Pat. No. 3,404,134. More preferably, the metal ions are selected from the group consisting of sodium, lithium, magnesium, zinc, aluminum, and mixtures thereof. Still more preferably, the metal ions are selected from the group consisting of sodium, zinc, and mixtures thereof. Sodium ions are more preferred, as a result of the high optical clarity they provide. Zinc ions are also more preferred, as a result of the high moisture resistance they provide.

Preferred ionomers have a melt index less than about 100 g/10 min, as measured by ASTM Method No. D1238 13 at a temperature of 190° C. and under a weight of 2.16 kg. More preferably, the ionomers have a melt index of about 0.1 to about 50 g/10 min, and still more preferably the ionomers have a melt index of about 0.5 to about 25 g/10 min or about 1 to about 10 g/10 min.

The acid copolymers may be neutralized by any suitable method to obtain the ionomers, for example by methods described in U.S. Pat. Nos. 3,404,134; 4,666,988; 4,774,290; and 4,847,164.

In some preferred embodiments, the terionomers comprise metal cations and are derived from an acid terpolymer that is about 5 to about 50% neutralized and that comprises about 60 to about 75 wt % of repeat units derived from an alpha-olefin, about 20 to about 25 wt % of repeat units derived from an alpha,beta-ethylenically unsaturated carboxylic acid having 2 to 8 carbons, and about 5 to about 15 wt % of repeat units derived from an ester of a second alpha,beta-ethylenically unsaturated carboxylic acid ester having 4 to 12 carbons. Another preferred acid terpolymer has a melt flow index from about 1 to about 100 g/10 min and comprises about 67.5 wt % of repeat units derived from ethylene, about 21.5 wt % of repeat units derived from methacrylic acid and about 10 wt % of repeat units derived from n-butyl acrylate. The preferred acid terpolymers are preferably neutralized with a sodium-containing base to the extent that the melt index of the resulting terionomer is about 2 to about 10 g/10 min.

In other preferred embodiments, the ionomer is produced from an acid dipolymer having a melt index of less than about 60 g/10 minutes and consisting essentially of from about 70 to about 79 wt % of repeat units derived from ethylene and from about 21 to about 30 wt % of repeat units derived from an alpha,beta-unsaturated carboxylic acid having from 2 to 8 carbons. The ionomer is produced by neutralizing about 15% to about 35% of the acid groups with a base that comprises metal ions. In a more preferred embodiment, the ionomer is derived from an acid copolymer that has a melt index of less than about 60 g/10 minutes or less and comprises about 78.3 wt % of repeat units derived from ethylene and about 21.7 wt % of repeat units derived from methacrylic acid. In this more preferred ionomer, about 26% of the acid groups are neutralized and the counterions are sodium cations. Further in this connection, preferred ionomers also include the high clarity ionomers that are described in U.S. Pat. Nos. 8,399,096 and 8,399,097.

The ionomeric composition used in the outer layers of the multilayer laminate and the EVA composition used in the inner layer may further comprise one or more additives that are known within the art. Suitable additives include, without limitation, plasticizers, processing aides, flow enhancing additives, lubricants, pigments, dyes, flame retardants, impact modifiers, nucleating agents to increase crystallinity, antiblocking agents such as silica, thermal stabilizers, UV absorbers, UV stabilizers, dispersants, surfactants, chelating agents, coupling agents, adhesives, primers, and the like, and mixtures or combinations of two or more additives. These additives are described in the Kirk Othmer Encyclopedia of Chemical Technology, 5th Edition, John Wiley & Sons (New Jersey, 2004), for example.

These additives may be present in the compositions in quantities that are generally from 0.01 to 15 wt %, preferably from 0.01 to 10 wt %, so long as they do not detract from the basic and novel characteristics of the composition and do not significantly adversely affect the performance of the composition or of the articles prepared from the composition. In this connection, the weight percentages of such additives are not included in the total weight percentages of the compositions defined herein. Typically, such additives may be present in amounts of from 0.01 to 5 wt %, based on the total weight of the composition. The optional incorporation of such conventional ingredients into the compositions can be carried out by any known process, for example, by dry blending, by extruding a mixture of the various constituents, by a masterbatch technique, or the like. See, again, the Kirk-Othmer Encyclopedia.

Additives of note include colorants, pigments, silane coupling agents, thermal stabilizers, UV absorbers, hindered amine light stabilizers (HALS), and additives that reduce the melt flow rate of the polymer composition. Typical colorants include a bluing agent to reduce yellowing, a colorant to color the laminate and a colorant to control solar light, such as an inorganic or organic infrared absorber.

The compositions may incorporate pigments at a level of 5 wt % or less, preferably 1 wt % or less, based on the total weight of the layer composition. The pigments are preferably transparent pigments that provide high clarity, low haze and other favorable optical properties. Generally, transparent pigments are nanoparticles. The pigment nanoparticles preferably have a nominal particle size of less than about 200 nm, more preferably less than about 100 nm, even more preferably less than about 50 nm and most preferably within the range of about 1 nm to about 20 nm. A preferred method for forming pigment concentrate compositions usable within the ionomer and EVA compositions is described in Intl. Patent Appln. Publn. No. WO01/00404, for example.

One or more silane coupling agents may be added to the polymer compositions to improve their adhesive strength. Examples of suitable silane coupling agents include, without limitation, γ-chloropropylmethoxysilane, vinyltrimethoxysilane, vinyltriethoxysilane, vinyltris(β-methoxyethoxy)silane, γ-vinylbenzylpropyl-trimethoxysilane, N-β-(N-vinylbenzylaminoethyl)-γ-aminopropyltrimethoxy-silane, γ-methacryloxypropyl-trimethoxysilane, vinyltriacetoxysilane, γ-glycidoxypropyl-trimethoxysilane, γ-glycidoxypropyltriethoxysilane, β-(3,4-epoxycyclohexyl)-ethyltrimethoxysilane, vinyltrichlorosilane, γ-mercapto-propylmethoxysilane, γ-aminopropyltriethoxy-silane, N-β-(aminoethyl)-γ-aminopropyltrimethoxysilane, and combinations of two or more thereof. The silane coupling agent(s) may be incorporated into the compositions at a level of about 0.01 to about 5 wt %, or about 0.05 to about 1 wt %, based on the total weight of the polymer composition.

The compositions may further incorporate one or more additives that effectively reduce the melt flow of the resin, to the limit of producing thermoset layers. The use of such additives will enhance the upper end use temperature of the multilayer polymeric sheet and the laminate produced from the sheet. Typically, the end use temperature will be enhanced, i.e., increased, by about 20° C. to 70° C. In addition, laminates produced from the enhanced materials will be more fire resistant. By reducing the melt flow of the compositions of the multilayer polymeric laminate, these compositions have a reduced tendency to melt and flow out of the laminate and, in turn, serve as additional fuel for a fire. Any known method for reducing the melt flow of the material can be used, including but not limited to peroxide cross linkage technology, electron beam technology, and epoxy cross linkage technology.

The use of thermal stabilizers, UV absorbers, and hindered amine light stabilizers is described in detail in U.S. Pat. No. 8,399,096. Briefly, however, the compositions may incorporate an effective amount of one or more thermal stabilizers. Any thermal stabilizer known within the art may find utility within the present invention. The compositions preferably incorporate from 0 to about 10.0 wt %, more preferably from 0 to about 5.0 wt %, and still more preferably from 0 to about 1.0 wt % of thermal stabilizers, based on the total weight of the composition.

The compositions may incorporate an effective amount of UV absorbers. Any UV absorber known within the art may find utility within the present invention. The compositions preferably incorporate from 0 to about 10.0 wt %, more preferably from 0 to about 5.0 wt %, and most preferably from 0 to about 1.0 wt % of UV absorbers, based on the total weight of the composition.

Finally, the compositions may incorporate an effective amount of hindered amine light stabilizers (HALS). Any hindered amine light stabilizer known within the art may find utility within the present invention. Generally, HALS are secondary, tertiary, acetylated, N-hydrocarbyloxy substituted, hydroxy substituted N-hydrocarbyloxy substituted, or other substituted cyclic amines which further incorporate steric hindrance, generally derived from aliphatic substitution on the carbon atoms adjacent to the amine function. The compositions preferably incorporate from 0 to about 10.0 wt %, more preferably from 0 to about 5.0 wt % and most preferably from 0 to about 1.0 wt % hindered amine light stabilizers, based on the total weight of the composition.

The multilayer polymeric sheets described herein may be formed by lamination, coextrusion, calendering, injection molding, blown film, dipcoating, solution coating, solution casting, blade, puddle, air-knife, printing, Dahlgren, gravure, powder coating, spraying, and other art processes. The parameters for each of these processes can be easily determined by one of ordinary skill in the art depending upon viscosity characteristics of the polymeric materials and the desired thickness of the layers of the laminate. Preferably, the multilayer polymeric sheets are produced through coextrusion processes or lamination processes.

The lamination process to produce the multilayer polymeric sheets generally involves forming a pre-press assembly, i.e., stacking the preformed layers in the desired order, followed by lamination. Any lamination process or combination of processes may be utilized, such as, for example, adhesive and/or tie layer lamination, solvent lamination, heat lamination and combinations thereof. Preferably, the preformed layers incorporate rough surfaces to facilitate the deairing during lamination processes.

More preferably, the multilayer polymeric sheets are formed through coextrusion processes. This provides a more efficient process by avoiding of the formation of a pre-press assembly and through reduced vacuum requirements during the lamination process. Coextrusion is particularly preferred for formation of “endless” products, such as sheets, which emerge as a continuous length. In coextrusion, generally each layer composition is provided from an individual extruder. If two or more of the layer compositions to be incorporated within the multilayer polymeric laminate are identical, they may be fed from the same extruder or from individual extruders, as desired. For each layer composition, the polymeric material, whether provided as a molten polymer or as plastic pellets or granules, is fluidized and homogenized. Additives, as described above, may be added, if desired. Preferably, the melt processing temperature of the polymeric compositions is from about 50° C. to about 300° C., more preferably, from about 100° C. to about 250° C. The polymeric compositions have excellent thermal stability, which allows for processing at high enough temperatures to reduce the effective melt viscosity. Recycled polymeric compositions may be used along with the virgin polymeric compositions. The molten materials are conveyed to a coextrusion adapter that combines the molten materials to form a multilayer coextruded structure. The layered polymeric material is transferred through an extrusion die opened to a predetermined gap. Die openings may be within a wide range. The extruding force may be exerted by a piston or ram (ram extrusion), or by a rotating screw (screw extrusion), which operates within a cylinder in which the material is heated and plasticized and from which it is then extruded through the die in a continuous flow. Single screw, twin screw, and multi-screw extruders may be used as known in the art. Different kinds of die are used to produce different products, such as sheets and strips (slot dies) and hollow and solid sections (circular dies). Generally, a slot die, (T-shaped or “coat hanger” die), is utilized to produce multilayer sheets. The die may be as wide as 10 feet and typically have thick wall sections on the final lands to minimize deflection of the lips from internal pressure.

The multilayer polymeric sheets are then drawn down to the intended gauge thickness by means of a primary chill or casting roll maintained at typically in the range of about 15° C. to about 55° C. The nascent multilayer cast sheet may be drawn down, and thinned significantly, depending on the speed of the rolls taking up the sheet. Typical draw down ratios range from about 1:1 to about 5:1 to about 40:1. The multilayer polymeric sheet is then taken up on rollers or as flat sheets, cooled and solidified. This may be accomplished by passing the sheet through a water bath or over two or more chrome-plated chill rolls that have been cored for water cooling. The cast multilayer polymeric sheet is then conveyed though nip rolls, a slitter to trim the edges, and then wound up or cut and stacked while preventing any subsequent deformation of the sheet.

The multilayer polymeric sheet of the present invention may have a smooth surface. If the multilayer polymeric sheet is to be used as an interlayer within a laminate, e.g., a light weight laminate, it preferably has a roughened surface to effectively allow most of the air to be removed from between the surfaces of the sheet during the lamination process. This may be accomplished, for example, by mechanically embossing the sheet after extrusion, as described above, or by melt fracture during extrusion.

Further provided herein are laminates that comprise the multilayer polymeric sheet and at least one additional sheet. Preferably, the additional sheet is a rigid layer, and more preferably the laminate comprises two rigid sheets.

The laminates described herein may be characterized by a variety of functional or decorative effects that include opacity or the diffusion of transmitted light. For example, the laminate may have a surface pattern or texture imparted upon it, or the interlayer may be pigmented as described above, or the laminate may include an additional sheet bearing an image. Preferably, however, the laminates described herein are optically clear, that is, they have a low value of haze and a high value of transmittance. Haze is the percentage of luminous flux that is scattered at an angle of more than 2.5 degrees from the axis defined by the path of unscattered light traveling through the laminate. Haze can be measured using a Hazegard hazemeter, available from BYK-Gardner USA of Columbia, Md. In addition, haze can be measured according to ASTM standard NF-54-111, which is in agreement with method A of ASTM standard D1003-61. Haze can also be measured according to Japanese Industrial Standard (JIS) K7136, using a Murakami Khikisai Haze Meter HM-150. Although the exact value of the haze measurement depends on the thickness of the interlayer and the cooling rate of the laminate (see, e.g., U.S. Pat. No. 8,399,096, issued to Hausmann et al.), the haze of the laminates is preferably 10% or less, preferably 5% or less, more preferably 2% or less, still more preferably 1.5% or less, 1% or less, or 0.5% or less, when the laminates are cooled at a rate of 5° C./min.

Percent transmittance represents the arithmetic average transmittance between 350 nm to 800 nm from a UV-Vis spectrometer. It is usually measured according to Japanese Industrial Standard (JIS) K7361. Again, the exact value of the transmittance depends on the thickness of the interlayer and the cooling rate of the laminate. Nevertheless, in preferred laminates having the structure glass/interlayer/glass, the transmittance is 75% or greater, 85% or greater, or greater than 95%.

The rigid sheet may be made of glass or a rigid transparent plastic, such as, for example, polycarbonate, acrylics, polyacrylate, cyclic polyolefins, such as ethylene norbornene polymers, metallocene-catalyzed polystyrene and the like and combinations thereof. Metal or ceramic plates may be substituted for the rigid polymeric sheet or glass if clarity is not required for the laminate.

Preferably, the rigid sheet is a glass sheet. The term “glass” as used herein refers to window glass, plate glass, silicate glass, sheet glass, float glass, colored glass, specialty glass that includes ingredients to control solar heating, glass coated with sputtered metals such as silver or indium tin oxide for solar control purposes, E-glass, Toroglass and Solex® glass. Examples of specialty glasses are described in U.S. Pat. Nos. 4,615,989; 5,173,212; 5,264,286; 6,150,028; 6,340,646; 6,461,736 and 6,468,934, for example. The type of glass to be selected for a particular laminate depends on the laminate's intended use.

A typical monolithic glass suitable for automotive end-uses is soda-lime-silica annealed float glass with a thickness of about 3.7 mm. As a rigid sheet in the laminates described herein, soda-lime-silica annealed float glass with a thickness of between about 0.7 mm and about 3.0 mm is preferred, and a thickness of about 1.0 to about 2.5 mm, or a thickness of about 2.3 mm, or about 2.0 mm, or about 1.6 mm, is particularly preferred. Other types of glass in this same range of relatively small thicknesses also find use in the laminates, including but not limited to heat strengthened glass, thermally tempered glass, and chemically-strengthened glass, as well as glass compositions including borosilicate glass, and aluminosilicate glass made by a float and fusion draw process. Additional descriptions of the use of relatively thin glass sheets that are also suitable for use in the laminates described herein is found in U.S. Patent Appln. Publn. Nos. 2012-0097219A1 and 2012-0094100A1.

The laminates described herein may be produced by any suitable process known in the art. In particular, the laminates may be produced by autoclave processes and by non-autoclave processes, as described below.

In a typical autoclave process, a glass sheet, an interlayer comprising a multilayer polymeric sheet of the present invention, and a second glass sheet are laminated together under heat and pressure and a vacuum (for example, in the range of about 25-30 inches (635-762 mm Hg)) to remove air. Preferably, the glass sheets have been washed and dried. In a typical procedure, the interlayer is positioned between the glass plates to form a glass/interlayer/glass pre-press assembly. The pre-press assembly is placed in a bag capable of sustaining a vacuum (“a vacuum bag”). Two types of vacuum bags can be used—either reusable bags or disposable bags. The pre-press assembly can be made in either kind of bag using vacuum and an oven. The pre-presses are then removed from the bag and placed in the autoclave. However, in the case of disposable bags, the laminate can stay in the bag and then be processed in the autoclave. The air is drawn out of the bag using a vacuum line or other means of pulling a vacuum on the bag. The bag is sealed while maintaining the vacuum. The sealed bag is placed in an autoclave at a temperature of about 80° C. to about 180° C., preferably between about 130° C. and about 180° C., at a pressure of about 200 psi (15 bars), for from about 10 to about 50 minutes. Preferably the bag is autoclaved at a temperature of from about 100° C. to about 160° C., preferably between about 120° C. and about 160° C. for 20 minutes to about 45 minutes. More preferably, the bag is autoclaved at a temperature of from about 105° C. to about 155° C., even more preferably from about 135° C. to about 155° C. for 20 minutes to about 40 minutes. Alternatively, the pre-press assembly can pass through one or more ovens, with a pre-press temperature of about 50° C. to about 80° C. in the first oven, and from about 80° C. to about 120° C. in the final oven. A vacuum ring may be substituted for the vacuum bag. One type of vacuum bag is described in U.S. Pat. No. 3,311,517.

In another alternative, any air trapped within the glass/interlayer/glass pre-press assembly may be removed by a nip roll process. For example, the glass/interlayer/glass pre-press assembly may be heated in an oven at between about 50° C. and about 150° C., preferably between about 60° C. and about 140° C., for about 30 minutes. Thereafter, the heated glass/interlayer/glass pre-press assembly is passed through a set of nip rolls so that the air in the void spaces between the glass and the interlayer may be squeezed out, and the edge of the assembly sealed.

The sealed and deaerated pre-press assembly may then be placed in an air autoclave and processed at a temperature between about 80° C. and about 160° C., preferably between about 90° C. and about 160° C., and at a pressure between about 100 psig to about 300 psig, preferably about 100 psig to about 200 psig (14.3 bar). These conditions are maintained for about 15 minutes to about 1 hour, preferably about 20 minutes to about 50 minutes, after which the air is cooled while no more air is added to the autoclave. After about 20 minutes of cooling, the excess air pressure is vented and the laminates are removed from the autoclave.

Non-autoclave lamination processes are described in U.S. Pat. Nos. 3,234,062; 3,852,136; 4,341,576; 4,385,951; 4,398,979; 5,536,347; 5,853,516; 6,342,116; 5,415,909; U.S. Patent Appln. Publn. No. 2004/0182493; European Patent No. EP 1 235 683 B1; and in Intl. Patent Appln. Publn. Nos. WO 91/01880 and WO 03/057478 A1, for example. Generally, non-autoclave processes include heating the pre-press assembly and the application of vacuum, pressure or both. For example, the pre-press assembly may be successively passed through heating ovens and nip rolls.

Adhesives, primers, and “additional layers” of polymeric sheets and films may be incorporated into the laminates described herein.

For architectural uses and for uses in transportation means such as automobiles, trucks, and trains, a typical laminate has two layers of glass, and the multilayer polymeric laminate interlayer described herein is directly self-adhered to the glass layers. The laminate generally has an overall thickness of about 1.5 mm to about 5.5 mm. The multilayer polymeric sheet typically has a thickness of about 0.3 mm to about 2.0, preferably about 0.35 to about 1.5 mm and each glass layer usually between about 0.5 and about 3.0 mm thick, preferably between about 1.0 and about 2.5 mm, or more preferably between about 1.0 and about 2.0 mm. When the interlayer is adhered directly to the glass, an intermediate adhesive layer or coating between the glass and the interlayer may not be required.

The multilayer polymeric sheets described herein provide benefits to the laminates produced therefrom, when compared to conventional laminates produced from single layer sheets known in the art or from known multilayer polymeric sheets having a different architecture or sublayer composition. Among the advantages of the materials of the present invention compared to monolithic glass are that the multilayer polymeric laminates exhibit one or more of improved sound transmission class (STC), reduced weight (areal density), and roughly equivalent effective thickness in bending. In particular, preferred laminates exhibit a sound transmission class of greater than 25, as measured by ASTM E314, or an effective stiffness by bending of about 3.0 mm to about 5.0 mm, as measured by ASTM C158. Also preferably, the laminate has a lower areal density than a monolithic glass of comparable thickness and bending strength.

The following examples are provided to describe the invention in further detail. These examples, which set forth specific embodiments and a preferred mode presently contemplated for carrying out the invention, are intended to illustrate and not to limit the invention.

### EXAMPLES AND COMPARATIVE EXAMPLE

### Methods of Preparation

### Extrusion Process

Tri-layer polymeric sheets were made by co-extrusion using two extruders, a multi-layer feedblock, and a 1200 mm single manifold coat-hanger sheet die. The die gap setting was adjusted to approximately 1 mm. The core material was extruded using a 50 mm single screw extruder operating at approximately 200° C. The outer layers were extruded using a 65 mm single screw extruder operating at approximately 200° C. Extruder throughputs were adjusted for target sheet constructions. A core layer throughput of approximately 50 kg/hr with an outer layer extruder throughput of approximately 100 kg/hr were used to produce items whose target construction is a 1/1/1 layer ratio. Both polymer streams were fed to the feedblock and die assembly. The outer layer polymer stream was split in the feedblock and manipulated into position to produce a tri-layer sheet. The sheeting was extruded through the die, cooled using chilled rolls and wound at constant speed of approximately 3 m/min.

### Standard Lamination Procedure

A pre-laminate assembly, in which the layers in the laminate are stacked in the desired order, was placed into a vacuum bag and sealed. A tube and coupling was inserted into the bag assembly and air was removed from within the bagged-laminate assembly by a vacuum pump. The absolute pressure within the bagged-assembly was reduced to less than 70 millibar to remove the majority of the air contained between the layers of the pre-press assembly prior to placing into the autoclave. The pre-laminate assembly was heated at 135° C. for 30 minutes in an air autoclave at a pressure of 200 psig (14.3 bar). The air was then cooled without adding additional gas, so that the pressure in the autoclave was allowed to decrease. After 20 minutes of cooling, when the air temperature was less than about 50° C., the excess pressure was vented, and the bagged-laminate assembly was removed from the autoclave. The autoclaved laminate was then removed carefully from the previously sealed vacuum bag.

### Analytical Methods

### Effective Thickness

The laminate effective thickness, t_{eff}, in bending for a 500 mm support span was determined according to the following procedure:
1. Measure the load (P)—deflection (δ) behavior using the four point bend test—ASTM C158 with modified sample size 150 mm×20 mm, supported on a 100 mm span (L₁) and loaded with a 50 mm span (L₂)
2. Calculate the laminate effective thickness, t_{eff}(100) for this 100 mm support span from the bend test measurements using eq. 1

t_{eff}(100)=[PL₃(3L₁²−4L₃²)/(4δEb)]^{1/3} (1)
where E is the glass Young's modulus (=71.6 GPa), b is the sample width (=20 mm) and L₃=(L₁−L₂)/2 (=25 mm).
3. Calculate the effective thickness for a 500 mm support span by transposing the results from steps 1 and 2 using the Wölfel theory specified in ASTM E1300-9 (X11).

This procedure is described in greater detail in U.S. Provisional Appln. No. 62/003,283 by Shitanoki et al., filed on May 27, 2014 (Attorney Docket No. PP0306 USPSP).

### Sound Transmittance Class (STC)

Sound transmission class (STC) was measured and calculated according to ASTM E413-10, which makes use of impedance values (transmission loss) measured according to ISO 16940 (2008).

### Examples 1 to 13 and Comparative Example A

Thirteen (13) laminates, numbered Examples 1 to 13, were prepared according to the standard lamination procedure set forth above. The trilayer interlayer sheets were prepared according to the standard extrusion method above with outer layers of terionomer (Polymer A) or ionomer (Polymer C) and with an inner layer of EVA (Polymer B). More specifically, Polymer C is the neutralization product of a dipolymer.

The thicknesses of the individual layers, as well as the overall thickness of the multilayer sheets and the nominal trilayer polymer structure ratios, are set forth in Table 1. The overall thickness of the trilayer sheeting was measured using a micrometer with flat measurement heads. The sheeting was measured across the sheet in three locations (left, center and right side) and the average of the three thickness measurements is reported in Table 1.

The thicknesses of the inner and outer layers of the trilayer sheets were calculated based on the feed ratios of the incoming resins through each extruder and into the feed block and die resulting in the multilayer sheet construction with the cited thicknesses as listed in Table 1. These layer thicknesses and layer ratios were found to be in good agreement when compared to inspection of the cross-section of the produced sheeting using a microscope and calibrated micrometer scale. Each sublayer was detectable due to the differences in refractive index between each resin comprising the multilayer structure.

Pre-press assemblies were formed by laying up the multilayer sheets between two sheets of soda-lime-silica annealed float glass having a thickness of 1.6 mm. Both lites of glass were positioned such that the tin-side of the glass was placed in contact with the multilayer sheeting for consistency (ATTA orientation). Without wishing to be held to theory, however, it is hypothesized that other glass orientations (ATAT or TAAT) would yield similar results. Therefore, it is hypothesized this specific glass orientation is not required to obtain the acoustical and stiffness benefits exhibited by the laminates described herein.

The pre-press assemblies were laminated according to the procedure set forth above. The thickness of the laminates was then measured using a flat-head micrometer at the mid-point of each side of the laminate. The numerical average of those readings is reported in Table 1.

Comparative Example A was a monolith of soda-lime-silica annealed float glass having a thickness of 3.7 mm. Its measured properties are also set forth in Table 1.

### Sound Transmission Class (STC)

The sound transmission class of Examples 1 to 13 and Comparative Example A was measured as described above, using a 150 mm beam rather than a standard 300 mm beam. The data in Table 1 demonstrate that the STC of the laminates was higher than that of the monolithic glass (Comparative Example A). Higher STC values are favorable in this context, as they indicate superior acoustic damping properties.

### Effective Thickness in Bending

The effective thickness of the laminates of Examples 1 to 13 and of Comparative Example A was determined by the procedure described above. The results in Table 1 demonstrate that the effective thickness of the laminates is approximately the same as that of Comparative Example A. These results indicate that the laminates have approximately the same bending strength as the monolithic glass.

### Areal Density

Areal density, a measure of the weight per unit area of a material, was calculated by weighing the laminated structure and then measuring the overall dimensions of the laminate and computing the areal density (areal density=mass/area). These values are reported in Table 1.

By comparing the areal densities of the laminated glass samples of Examples 1 to 13 with that of monolithic glass of Comparative Example A, it can be seen that the laminated glass samples weigh less per area than the monolithic glass.

In summary, these results demonstrate that the laminates of Examples 1 to 13 have superior sound damping qualities and approximately equal strength, when compared to a monolithic glass sheet. Yet, the laminates also provide significant weight savings of 5 to 10%, as demonstrated by the differences in areal density of the laminates and the monolithic glass sheet.

While certain of the preferred embodiments of this invention have been described and specifically exemplified above, it is not intended that the invention be limited to such embodiments. Various modifications may be made without departing from the scope and spirit of the invention, as set forth in the following claims.

TABLE 1

| | | Nominal | | | Trilayer | | | | | |
|---|---|---|---|---|---|---|---|---|---|---|
| | | Trilayer | Trilayer | | Polymer | | | | | Laminate |
| | Trilayer | Polymer | Polymer | Glass 1 | Total | Glass 2 | Total | | Sound | Effective |
| | Polymer | Structure | Structure | Thickness | Thickness | Thickness | Thickness | Areal Density | Transmission | Thickness in |
| Example | Composition | Ratio | (mm) | (mm) | (mm) | (mm) | (mm) | (kg/m²) | Class (STC) | Bending (mm) |
| 1 | Polymer A/ | 2\|5\|2 | 0.17\|0.43\|0.17 | 1.6 | 0.77 | 1.6 | 3.97 | 8.76 | 29 | 3.80 |
| 2 | Polymer B/ | 1\|1\|1 | 0.27\|0.27\|0.27 | 1.6 | 0.81 | 1.6 | 4.01 | 8.80 | 29 | 3.91 |
| 3 | Polymer A | 4\|1\|4 | 0.33\|0.08\|0.33 | 1.6 | 0.75 | 1.6 | 3.95 | 8.74 | 29 | 4.02 |
| 4 | | 1\|1\|1 | 0.22\|0.22\|0.22 | 1.6 | 0.66 | 1.6 | 3.86 | 8.65 | 29 | 3.79 |
| 5 | | 2\|5\|2 | 0.09\|0.23\|0.09 | 1.6 | 0.41 | 1.6 | 3.61 | 8.41 | 29 | 3.51 |
| 6 | | 1\|1\|1 | 0.13\|0.13\|0.13 | 1.6 | 0.39 | 1.6 | 3.59 | 8.39 | 29 | 3.56 |
| 7 | | 4\|1\|4 | 0.18\|0.05\|0.18 | 1.6 | 0.41 | 1.6 | 3.61 | 8.41 | 28 | 3.61 |
| 8 | Polymer C/ | 2\|5\|2 | 0.18\|0.44\|0.18 | 1.6 | 0.80 | 1.6 | 4.00 | 8.79 | 29 | 3.83 |
| 9 | Polymer B/ | 1\|1\|1 | 0.28\|0.28\|0.28 | 1.6 | 0.84 | 1.6 | 4.04 | 8.83 | 29 | 3.92 |
| 10 | Polymer C | 4\|1\|4 | 0.36\|0.09\|0.36 | 1.6 | 0.81 | 1.6 | 4.01 | 8.80 | 29 | 4.02 |
| 11 | | 2\|5\|2 | 0.10\|0.24\|0.10 | 1.6 | 0.43 | 1.6 | 3.63 | 8.43 | 29 | 3.51 |
| 12 | | 1\|1\|1 | 0.13\|0.13\|0.13 | 1.6 | 0.40 | 1.6 | 3.60 | 8.40 | 28 | 3.56 |
| 13 | | 4\|1\|4 | 0.18\|0.04\|0.18 | 1.6 | 0.40 | 1.6 | 3.60 | 8.40 | 28 | 3.61 |
| Comp. A | NA | NA | | 3.7 | NA | NA | 3.7 | 9.25 | 25 | 3.70 |

What is claimed is:

1. A laminate comprising a multilayer polymeric sheet and at least one additional layer;
wherein the multilayer polymeric sheet comprises two outer layers and an inner layer, wherein the two outer layers are positioned on either side of the inner layer;
wherein the inner layer comprises an ethylene vinyl acetate composition; and
wherein the two outer layers are the same or different and comprise an ionomeric composition; the ionomeric composition comprises an ionomer; and the ionomer is a product of neutralizing an acid copolymer;
wherein the acid copolymer comprises copolymerized repeat units derived from an alpha-olefin, about 0.1 to about 30 wt % of copolymerized repeat units derived from a first alpha,beta-ethylenically unsaturated carboxylic acid having 3 to 8 carbon atoms, and optionally about 2 to about 25 wt % of copolymerized repeat units derived from an ester of a second alpha,beta-ethylenically unsaturated carboxylic acid, said ester having 4 to 12 carbon atoms; and the first and the second alpha,beta-ethylenically unsaturated carboxylic acids are the same or different;
wherein the weight percentages are based on the total weight of the acid copolymer and the sum of the weight percentages of the copolymerized residues in the acid copolymer is 100 wt %; and wherein about 5% to about 100% of the carboxylic acid groups in the acid copolymer are neutralized with one or more bases that contain a metal cation; and
wherein the laminate has a sound transmission class of greater than 25, as measured by ASTM E314; or wherein the laminate has an effective stiffness by bending of about 3.0 mm to about 5.0 mm, as measured by ASTM C158.

2. The laminate of claim 1, wherein the outer layers have a thickness between about 0.1 mm and about 1.5 mm;
wherein the inner layer has a thickness between about 0.1 mm and about 1.5 mm; and
wherein the total thickness of the multilayer polymeric sheet is between about 0.3 mm and about 2.0 mm.

3. The laminate of claim 1, wherein the ratio of the thicknesses of the layers of the multilayer polymeric sheet, given in the order “outer layer/inner layer/outer layer”, is selected from the group consisting of 1/1/1, 2/5/2, and 4/1/4.

4. The laminate of claim 1, wherein the ethylene vinyl acetate composition comprises a poly(ethylene-co-vinyl acetate) polymer, and the poly(ethylene-co-vinyl acetate) polymer comprises at least about 25 wt % of copolymerized repeat units derived from vinyl acetate, based on the total weight of the poly(ethylene-co-vinyl acetate) polymer.

5. The laminate of claim 4, wherein the poly(ethylene-co-vinyl acetate) polymer comprises between 30 and 50 wt % of copolymerized repeat units derived from vinyl acetate; or wherein the poly(ethylene-co-vinyl acetate) polymer has a melt flow index of about 14 g/10 min before crosslinking and a melt flow index of less than or equal to 2 g/10 min after crosslinking, as measured by ASTM Method No. D1238-13 at a temperature of 190° C. and under a weight of 2.16 kg.

6. The laminate of claim 1, wherein the acid copolymer is an acid terpolymer comprising copolymerized repeat units derived from ethylene, about 20 to about 25 wt % of copolymerized repeat units derived from acrylic acid or methacrylic acid, and about 7 to about 15 wt % of copolymerized repeat units derived from an alkyl ester of acrylic acid or methacrylic acid.

7. The laminate of claim 1, wherein the acid copolymer is an acid dipolymer comprising from about 70 to about 79 wt % of copolymerized residues of ethylene and from about 21 to about 30 wt % of copolymerized residues of the first alpha,beta-ethylenically unsaturated carboxylic acid.

8. The laminate of claim 1, wherein the acid copolymer has a melt index of about 100 g/10 minutes or less; or wherein the ionomer has a melt flow index of from about 0.1 to about 50 g/10 min, as measured by ASTM Method No. D1238-13 at a temperature of 190° C. and under a weight of 2.16 kg.

9. The laminate of claim 1, wherein about 15% to about 35% of the carboxylic acid groups in the first alpha,beta-ethylenically unsaturated carboxylic acid are neutralized; or wherein the acid copolymer is neutralized with a base that contains sodium ions to form the ionomer.

10. The laminate of claim 1, wherein the ethylene vinyl acetate composition or the ionomeric composition(s) comprise one or more additives selected from the group consisting of colorants, pigments, silane coupling agents, thermal stabilizers, UV absorbers, hindered amine light stabilizers (HALS), additives that reduce the melt flow rate of the ethylene vinyl acetate composition or the ionomeric composition(s) composition, plasticizers, processing aides, flow enhancing additives, lubricants, dyes, flame retardants, impact modifiers, nucleating agents to increase crystallinity, antiblocking agents, UV stabilizers, dispersants, surfactants, chelating agents, coupling agents, adhesives and primers.

11. The laminate of claim 10 that comprises the pigment, wherein the pigment is a transparent pigment comprising nanoparticles having a nominal particle size of less than about 200 nm.

12. The laminate of claim 1, wherein the at least one additional layer is a layer of glass.

13. The laminate of claim 12, further comprising a second layer of glass;
wherein said multilayer polymeric sheet is placed between said two layers of glass and laminated to form the laminate.

14. The laminate of claim 13, wherein each layer of glass has a thickness between about 0.7 mm and about 3.0 mm; and wherein the total thickness of the laminate is between about 1.5 mm and about 7.5 mm.

15. The laminate of claim 13, wherein the areal density of the laminate is lower than that of a glass monolith, said glass monolith having a thickness approximately equal to the thickness of the laminate; and wherein the bending stiffness of the laminate is greater than or equal to the bending stiffness of the glass monolith.
